(19) United States
(12) Patent Application Publication
(10) Pub. No.: US 2017/0209901 A1
(43) Pub. Date: Jul. 27, 2017

(54) Vibratory Apparatus With Deck Panel And Assembly Method

(71) Applicant: General Kinematics Corporation, Crystal Lake, IL (US)

(72) Inventors: Kerry Willliam Quinn, Palatine, IL (US); Steve Massman, Poplar Grove, IL (US); Justen Healless, Woodstock, IL (US)

(21) Appl. No.: 15/007,935

(22) Filed: Jan. 27, 2016

(51) Int. Cl. B07B 1/46; B07B 1/28

(52) U.S. Cl. CPC B07B 1/4609; B07B 1/28

(57) ABSTRACT

A deck panel includes a panel base having a top defining an upper, load-bearing surface, a bottom disposed opposite the top, and first and second opposite sides, a plurality of passages, each passage connected between an upper opening disposed in the upper, load-bearing surface and a lower opening on the bottom, and first and second guards depending from the bottom of the panel base, each of the guards disposed along one of the first and second opposite sides with the plurality of passages disposed between the two guards.

### BACKGROUND

This patent is directed to a vibratory apparatus having a deck and a method for assembling the deck, and, in particular, to a vibratory screening apparatus having a deck including a plurality of deck panels and a method for assembling the plurality of deck panels to form the deck.

The deck of a vibratory apparatus, such as a vibratory screening apparatus or screen, can experience significant wear over the apparatus's lifetime. The movement of material relative to the deck, which may involve movement along the surface of the deck as well as movement vertically relative to the deck, can cause the deck to become worn and/or damaged to the point where the deck needs to be repaired or replaced. Repair or replacement of a traditional deck can be a lengthy process, and costly in terms of parts and labor. Where the apparatus has been installed in a space that restricts the possibilities for replacement, the repair may become even more complicated.

To reduce the time and expense required to perform such repairs, modular decks have been designed that divide or portion the deck into a number of deck modules or panels. Such modular decks typically include a frame that is attached or secured to the remainder of the vibratory apparatus, and then the deck panels are disposed or supported on top of the frame. Materials are then directed over the deck panels, and potentially through the deck panels as well (in the case of a screen, for example). A single deck may include a large number of individual deck panels.

With a modular deck, it is no longer necessary to remove and replace the entire deck when only one portion of the deck is worn or damaged and needs to be repaired or replaced. The ability to repair or replace only a section of the deck to address localized wear or damage can reduce the cost of the repair (in terms of labor and materials) and the time required to perform the repair. A reduction in the time required to perform the repair can lead to shorter down-time for the apparatus. Furthermore, because of the size of the panel (relative to the entire deck), it may be easier to repair such a deck even when the apparatus is installed in a space with relatively small clearances about the apparatus.

### SUMMARY

According to one aspect of the present disclosure, a vibratory apparatus includes a deck and an exciter coupled to the at least one deck. The deck includes at least one deck panel. The at least one deck panel includes a panel base having a top defining an upper, load-bearing surface, a bottom disposed opposite the top, and first and second opposite sides, a plurality of passages, each passage connected between an upper opening disposed in the upper, load-bearing surface and a lower opening on the bottom, and first and second guards depending from the bottom of the panel base, each of the guards disposed along one of the first and second opposite sides with the plurality of passages disposed between the two guards.

According to another aspect of the present disclosure, a deck panel includes a panel base having a top defining an upper, load-bearing surface, a bottom disposed opposite the top, and first and second opposite sides, a plurality of passages, each passage connected between an upper opening disposed in the upper, load-bearing surface and a lower opening on the bottom, and first and second guards depending from the bottom of the panel base, each of the guards disposed along one of the first and second opposite sides with the plurality of passages disposed between the two guards.

According to yet another aspect of the present disclosure, a vibratory apparatus includes a deck and an exciter coupled to the at least one deck. The deck includes at least one deck panel, and at least one deck panel includes a plurality of panel modules. Each panel module includes a panel base having a top defining an upper, load-bearing surface, a bottom disposed opposite the top, and first and second opposite sides, a plurality of passages, each passage connected between an upper opening disposed in the upper, load-bearing surface and a lower opening on the bottom, and first and second guards depending from the bottom of the panel base, each of the guards disposed along one of the first and second opposite sides with the plurality of passages disposed between the two guards.

### BRIEF DESCRIPTION OF THE DRAWINGS

It is believed that the disclosure will be more fully understood from the following description taken in conjunction with the accompanying drawings. Some of the figures may have been simplified by the omission of selected elements for the purpose of more clearly showing other elements. Such omissions of elements in some figures are not necessarily indicative of the presence or absence of particular elements in any of the exemplary embodiments, except as may be explicitly delineated in the corresponding written description. None of the drawings is necessarily to scale.

FIG. 1 is a side view of an embodiment of a vibratory apparatus according to the present disclosure;

FIG. 2 is a perspective view of an embodiment of a deck panel for use in the vibratory apparatus of FIG. 1;

FIG. 3 is a perspective view, in partial cross-section, of a plurality of the deck panels of FIG. 2 assembled to form a portion of the deck of the vibratory apparatus of FIG. 1;

FIG. 4 is an alternative representation of the deck panels in FIG. 3, illustrating each deck panel as a plurality of deck panel modules;

FIG. 5 is a top perspective view of an embodiment of an end deck panel module;

FIG. 6 is a bottom perspective view of the end deck panel module of FIG. 5;

FIG. 7 is a plan view of the end deck panel module of FIG. 5;

FIG. 8 is an end view of the end deck panel module of FIG. 5;

FIG. 9 is a side view of the end deck panel module of FIG. 5;

FIG. 10 is a top perspective view of an embodiment of an intermediate deck panel module;

FIG. 11 is a bottom perspective view of an embodiment of the intermediate deck panel module of FIG. 10; and

FIG. 12 is a perspective view of an alternative embodiment of the deck panel of FIG. 2, illustrating an intermittent form of the guards.

### DETAILED DESCRIPTION OF VARIOUS EMBODIMENTS

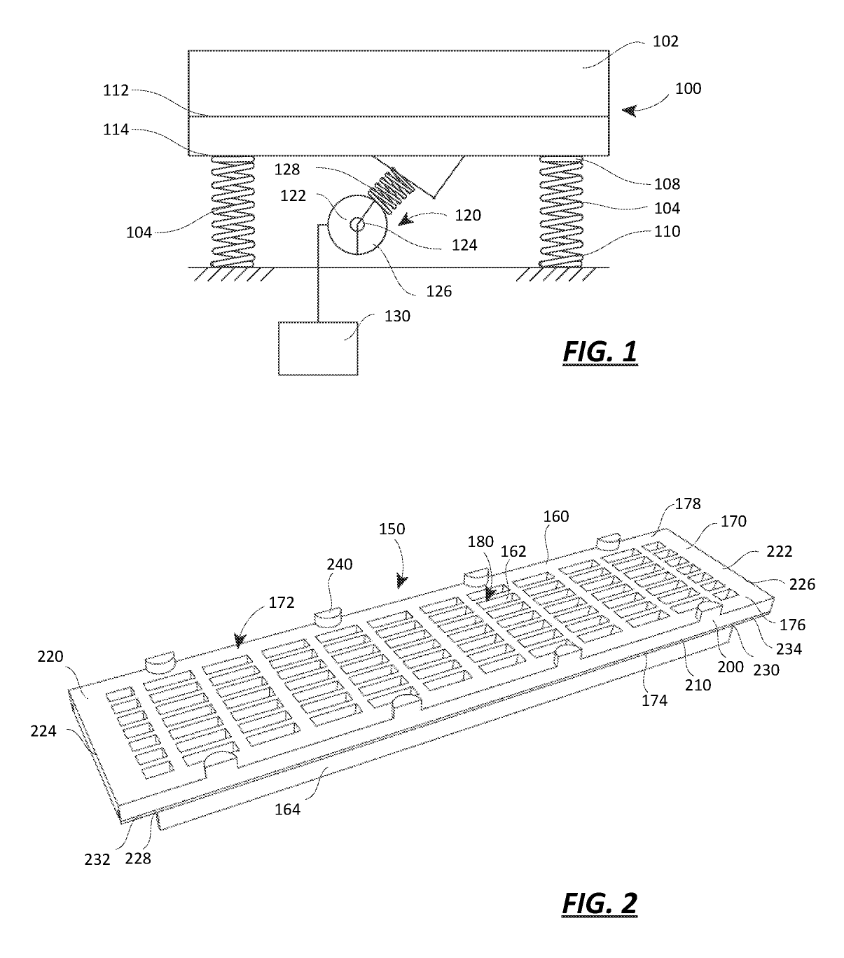

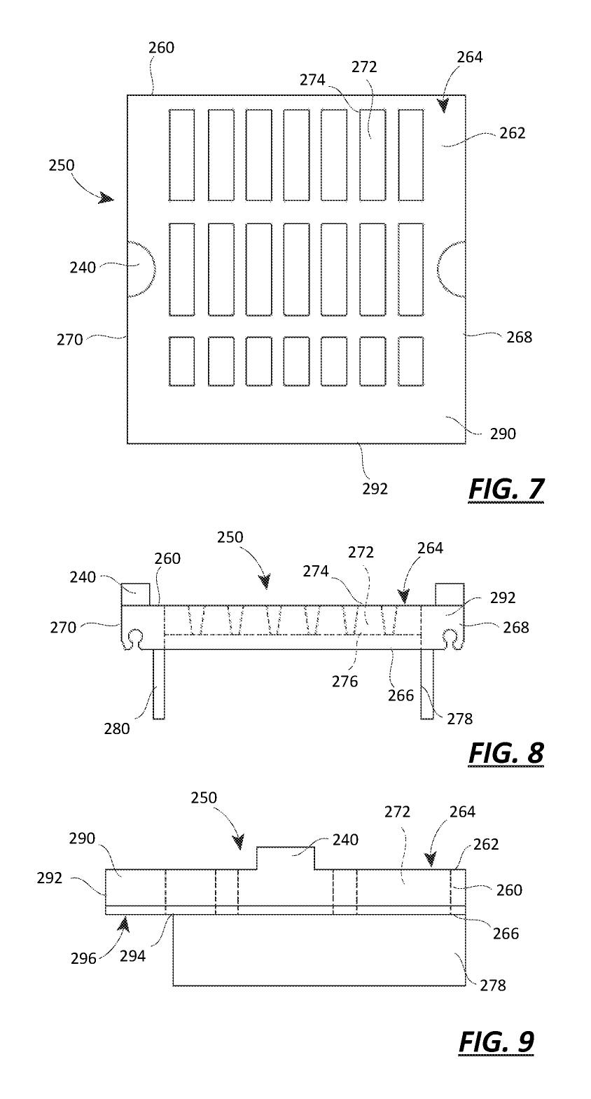

FIG. 1 illustrates an embodiment of a vibratory apparatus 100 that may have a deck according to the present disclosure. This embodiment is intended to be a non-limiting example of the possible apparatuses that may have a deck formed of deck panels such as those illustrated in FIGS. 2-11. It will be recognized that considerable variation may occur, for example, relative to the structures that support and/or balance the trough and in the manner and shape of the exciter, as will be touched on briefly below.

The apparatus 100 may include a trough 102 that is supported above a surface by a plurality of resilient members 104. According to certain embodiments, the resilient members 104 may be paired with linkages. The resilient members 104 may be attached at one end 108 to the trough 102 and at a second end 110 to the surface, often via a support structure that may be bolted or otherwise secured to the surface. The trough 102 may have a deck 112 disposed therein, the details of which are discussed below. The trough 102 may include a floor 114 beneath the deck 112, as illustrated, or there may be an opening in the trough 102 beneath the deck 112. Further, the deck 112 may include other structures other than the deck panels described below.

One or more exciters 120 may be coupled to the trough 102. The exciter 120 may include a motor 122 having a shaft 124 to which one or more eccentric weights 126 are attached, for example. According to other embodiments, the exciter 120 may include pneumatic and/or hydraulic actuators instead of the motor 122. For that matter, the shaft 124 and weights 126 may be attached to the trough 102, while the motor 122 is coupled to the shaft 124, but not mounted on the apparatus 100.

The motor 122, shaft 124 and weights 126 (or simply the shaft 124 and weights 126) may be coupled to the trough 102 via one or more resilient members 128, as illustrated. It will be recognized that the motor 122 may instead be coupled directly to the trough 102, or to a counterbalance that is then attached to the trough 102. It will also be recognized that one or more weights or stabilizers may be used in conjunction with the motor 122.

The exciter 120 may cause motion of the trough 102 and associated deck 112, as well as motion of objects supported on the deck 112. The exciter 120 may cause the objects to move from one end of the trough 102 to the other (for example, in a series of “catches and throws”), may cause the objects to move up and down without significant lateral motion relative to either end, or some combination thereof. The operation of the exciter 120 may be controlled by a controller 130 that may be coupled to the exciter 120, particularly to the motor 122 and/or the weights 126 (which may be variable as to their center of mass relative to the shaft 124, for example). The controller 130 may be programmable, and may vary the operation of the exciter 120 (via the motor 122 and/or weights 126) such that objects move along the deck 112, move up and down relative to the deck 112, and then resume their motion along the deck 112, for example.

As noted above, according to an embodiment of the present disclosure, the deck 112 of the vibratory apparatus 100 is formed from a plurality of deck panels 150, an embodiment of which is illustrated in FIG. 2. The deck panels 150 may be attached to a frame 152, as illustrated in FIG. 3. The frame 152 is attached to the trough 102 (and in particular sidewalls of the trough 102) and then the panels 150 are attached to the frame 152, as explained in greater detail below with respect to the illustrated embodiment. The assembly illustrated in FIG. 3 is an example of a portion of one row of panels 150 that may be disposed between the sidewalls of the trough 102 to define the deck 112. The full row may include, and typically does include, more than the three deck panels illustrated.

As illustrated in FIGS. 2 and 3, the deck panel 150 includes a panel base 160, a plurality of passages 162 and a pair of guards 164, 166. More particularly, the panel base 160 has a top 170 defining an upper, load-bearing surface 172, a bottom 174 disposed opposite the top 170, and first and second sides 176, 178 disposed opposite each other. The plurality of passages 162 are formed in and through the panel base 160. Each passage 162 is connected between an upper opening 180 disposed in the upper, load-bearing surface 172 and a lower opening 182 on the bottom 174. The guards 164, 166 depend from the bottom 174 of the panel base 160. Each of the guards 164, 166 is disposed along one of the first and second opposite sides 176, 178 of the panel base 160 with the plurality of passages 162 disposed between the two guards 164, 166.

As illustrated in FIG. 3, the deck frame 152 is disposed below the deck panels 150, and the deck panels 150 are attached or connected to the deck frame 152. The deck frame 152 may include a plurality of longitudinal beams 190 and a plurality of transverse cross-members 192. According to an embodiment, the longitudinal beams 190 extend along the length of the vibratory apparatus 100, while the transverse members 192 extend across the width of the apparatus 100 between the sidewalls. According to an alternative embodiment, the beams 190 may be oriented across the width of the apparatus, with the members 192 oriented along the length. Formed on the longitudinal beams 190 are one of a pair of connectors, the other of the connectors being disposed on the deck panels 150. As illustrated, a longitudinally-directed male connector 194 is attached to the longitudinal beams 190 while a female connector 196, 198 is formed in the bottom of the deck panel 150. According to other embodiments, the male and female connectors may be reversed relative to the panels 150 and frame 152, or other types of connectors or connector assemblies may be used.

As illustrated, the deck panel 150 includes a first female connector 196 disposed between the first guard 164 and a first longitudinal side edge 200. The deck panel 150 also includes a second female connector 198 disposed between the second guard 166 and a second longitudinal side edge 202 disposed opposite the first side edge 200. One of the male connectors 194 is received in the first female connector 196, while another of the male connectors 194 is received in the second female connector 198. The cooperation of the male and female connectors 194, 196, 198 may be such that the panel 150 is secured to the frame 152 under operating conditions, but the panel 150 may be separated from the frame by decoupling the connectors 194, 196, 198, which decoupling may require the use of a tool or may simply be the result of forces applied to the panel 150 in a fashion unlikely to occur under operating conditions.

As illustrated in FIG. 3, the guards 164, 166 depend from the base 160 of the panel 150 to such an extent that the longitudinal beams 190 are shielded from material passing through the passages 162. That is, the guards 164, 166 present an inner surface 204, 206 against which materials that exit the passages 162 may contact instead of contacting the beams 190. Phrased slightly differently, the longitudinal beams 190 are disposed between guards 164, 166 of adjacent panels 150. Consequently, the amount of material contacting the beams 190 may be reduced, such that the need to repair and/or replace the beams 190 (which can be a very labor intensive process considering the attachment of the beams 190 to the remainder of the trough 102) may be reduced or eliminated. Furthermore, because the panels 150 are removable, if the wear on the guard 164, 166 is to such an extent that the guard 164, 166 no longer performs its intended function, the panel 150 may be removed and replaced, such as it would if the base 160 (and in particular the surface 172) is worn to a degree that the panel 150 fails to adequately perform its function of separating materials of different sizes.

A method of assembling a deck 112 using the aforementioned deck panels 150 may include disposing at least one deck panel 150 on a deck frame 152, the at least one deck panel 150 including a panel base 160 having a top 170 defining an upper, load-bearing surface 172, a bottom 174 disposed opposite the top 170, and first and second sides 176, 178 disposed opposite each other, a plurality of passages 162, each passage 162 connected between an upper opening 180 disposed in the upper, load-bearing surface 172 and a lower opening 182 on the bottom 174, and first and second guards 164, 166 depending from the bottom 174 of the panel base 160, each of the guards 164, 166 disposed along one of the first and second opposite sides 176, 178 with the plurality of passages 162 disposed between the two guards 164, 166. The method may also include securing the at least one deck panel 150 to the deck frame 152. According to one embodiment, the securing of the at least one deck panel 150 to the deck frame 152 may be reversible (i.e., the at least one deck panel 150 may be decoupable or detachable from the deck frame 152 without altering or damaging the deck frame 152). According to other embodiments, the at least one deck panel 150 may be permanently secured (i.e., incapable of being decoupled or detached from the deck frame 152 without altering or damaging the deck frame 152).

More particularly, the method may include coupling a connector attached to or part of the deck panel 150 with a connector attached to or part of the deck frame 152. For example, the deck frame 152 may include at least one male connector 194 and the at least one deck panel 150 may include at least one female connector 196, 198, and the method may include disposing the male connector 194 within the female connector 196, 198. Where the male and female connectors 194, 196, 198 are as illustrated in FIG. 3, the method may include inserting the male connector 194 into the female connector 196, 198.

The method may also include decoupling or detaching the at least one deck panel 150 from the deck frame 152, and securing at least one replacement deck panel 150 to the deck frame 152 in place of the at least one deck panel 150 removed from the deck frame 152.

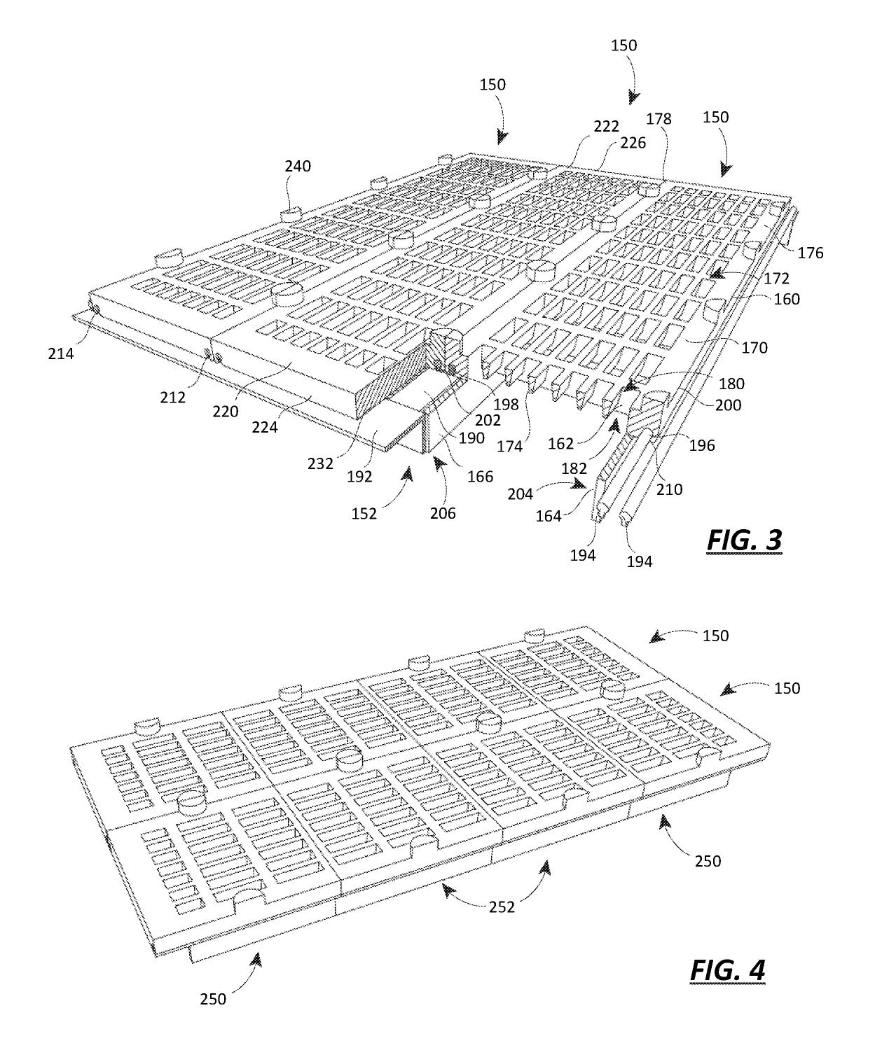

Having thus described the vibratory apparatus 100 with deck 112 made using deck panels 150 and methods of assembly utilizing the deck panels 150, we now describe the further details of the deck panels 150 with reference to FIGS. 2 and 3, and then with reference to FIGS. 4-11.

According to the illustrated embodiment, the panel base 160 comprises a rectangular parallelepiped, having a length in a longitudinal direction that is considerably greater than its width in a transverse direction, or its thickness. According to other embodiments, the shape of the panel base 160 may be of a different shape. In addition, the panel base 160 may be referred to as a rectangular parallelepiped despite the fact that, for example, not all of the corners of the panel base 160 are perfectly right or square in cross-section (see the bottom corners 210 in FIG. 3).

The first side 176 of the panel base 160 terminates at the first longitudinal side edge 200, and the second side 178 of the panel base 160 terminates at the second longitudinal side edge 202, as mentioned above. Referring to FIGS. 2 and 3, it will be noted that the first guard 164 is spaced from the first side edge 200 and the second guard 166 is spaced from the second side edge 202. According to the illustrated embodiment, the first and second female connectors 196, 198, in the form of first and second channels 212, 214, are also disposed on the bottom 174 of the deck panel base 160. In particular, the first channel 212 is disposed between the first side edge 200 and the first guard 164 and the second channel 214 is disposed between the second guard 166 and the second side edge 202.

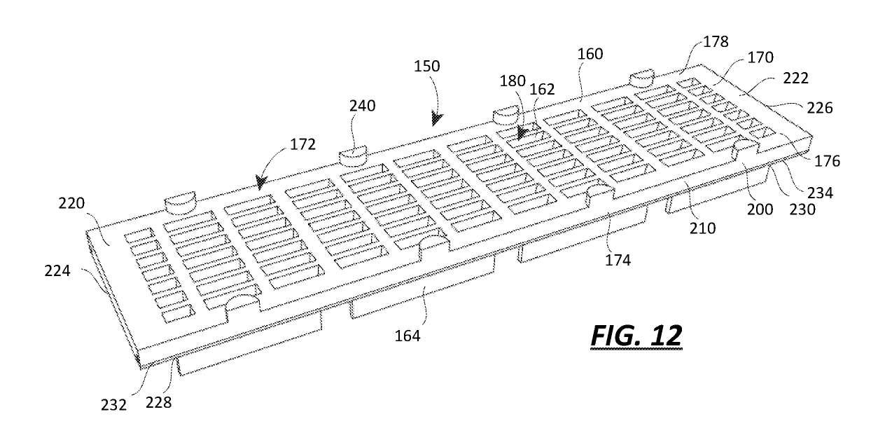

Furthermore, the panel base 160 has first and second ends 220, 222 disposed opposite each other, in addition to the top 170, bottom 174 and opposite sides 176, 178. The first and second guards 164, 166 depend from the bottom 174 of the panel base 160 between the first end 220 and the second end 222 of the panel base 160 (i.e., from one end of the panel base 160 to the other). According to certain embodiments, the first and second guards 164, 166 may depend from the bottom 174 of the panel base 160 continuously (i.e., without spaces or breaks) between the first end 220 and the second end 222. According to alternate embodiments, the first and second guards 164, 166 may depend from the bottom 174 of the panel base 160 intermittently (i.e., with spaces, gaps or breaks) between the first end 220 and the second end 222 (see FIG. 12).

In fact, as illustrated, the first end 220 of the panel base 160 terminates at a first transverse end edge 224 and the second end 222 of the panel base 160 terminates at a second transverse end edge 226. As is also illustrated in FIG. 2, the first and second guards 164, 166 depending from the bottom 174 of the panel base 160 between a first point 228 spaced from the first end edge 224 to a second point 230 spaced from the second end edge 226 to define a first overhang 232 at the first end 220 and a second overhang 234 at the second end 222. The guards 164, 166 may depend between these points 228, 230 continuously or intermittently.

Each of the guards 164, 166 also may be a rectangular parallelepiped in shape, disposed at right angles to the panel base 160. However, this is not a requirement for all embodiments of the present disclosure. For example, the guards 164, 166 may be tapered in cross-section, and may be disposed at an angle relative to the panel base 160 such that the bottommost ends of the guards 164, 166 either converge towards each other or away from each other. The guards 164, 166 may vary along the length of the guard 164, 166 (i.e., between the first and second ends 220, 222 of the panel base 160). For example, the guard 164, 166 may assume a sinusoidal or sawtooth shape between one end and the other end 220, 222.

Furthermore, as illustrated, the guards 164, 166 are formed as a single unit or piece with the panel base 160. For example, the guards 164, 166 may be molded with the panel base 160 as a single unit. The single unit or piece may be molded using a polymer such as polyurethane, for example. According to alternate embodiments of the present disclosure, the guards 164, 166 may be formed separately from and then attached to the bottom of the panel base 160, using an adhesive, for example.

As noted above, a plurality of passages 162 are formed in the panel base 160. As illustrated, the openings 180 in the upper, load-bearing surface 172 may be generally rectangular. According to other embodiments, the openings 180 may have another shape, such as square or circular. Further, the plurality of passages 162 are disposed in a plurality of parallel, transverse rows, each row disposed between the first guard 164 and the second guard 166, and none of the plurality of passages 162 disposed in the first overhang 232 or the second overhang 234. Again, according to other embodiments, it is not necessary that the passages 162 be arranged in parallel, transverse rows or that none of the passages be located in the overhangs 232, 234.

While the deck panel 150 has been described relative to the vibratory apparatus 100 of which it is a part, it will also be recognized that the panel 150 may, in and of itself, represent an embodiment of an invention. As such, the inventive deck panel 150 may include a panel base 160 having a top 170 defining an upper, load-bearing surface 172, a bottom 174 disposed opposite the top 170, and first and second opposite sides 176, 178 disposed opposite each other, a plurality of passages 162, each passage 62 connected between an upper opening 180 disposed in the upper, load-bearing surface 172 and a lower opening 182 on the bottom 174, and first and second guards 164, 166 depending from the bottom 174 of the panel base 160, each of the guards 164, 166 disposed along one of the first and second opposite sides 176, 178 with the plurality of passages 162 disposed between the two guards 164, 166. Furthermore, such a deck panel 150 may include any of the variations described above as alternate embodiments.

The deck panel 150 may include other features than those described above. For example, each deck panel 150 may include a plurality of semi-cylindrical posts 240 disposed on the top 170 of the panel base 160. The posts 240 may define a plurality of cylindrical posts when the panels 150 are disposed with the first side 176 of a first panel 150 abutting the second side 178 of a second panel 150, as illustrated in FIG. 3. The posts 240 redirect material flowing over the surface 172 of the panel 150 toward the passages 162, and in particular the openings 180 in the surface 172. Other alternative features may include textures or coatings for the surface 172, for example.

The deck panel 150 may also be described as including a plurality of panel modules 250, 252. FIG. 4 illustrates how two of the deck panels 150 from FIG. 3 may be represented as a plurality of deck modules 250, 252. It will be recognized that the deck modules 250, 252 may be used to describe the structure of a single deck panel 150, the deck modules 250, 252 being formed together (e.g., by molding) as a single unit, or the deck modules 250, 252 may be separate units, which as an assembly provide the structure of a single deck panel 150 as descried above. The modules 250, 252 may even be secured to the deck frame 152 separately according to such an embodiment.

According to FIGS. 4-11, each panel module 250, 252 includes a panel base 260 having a top 262 defining an upper, load-bearing surface 264, a bottom 266 disposed opposite the top 262, and first and second opposite sides 268, 270 disposed opposite each other. The panel module 250, 252 also includes a plurality of passages 272, each passage 272 connected between an upper opening 274 disposed in the upper, load-bearing surface 264 and a lower opening 276 on the bottom 266, and first and second guards 278, 280 depending from the bottom 266 of the panel base 260, each of the guards 278, 280 disposed along one of the first and second opposite sides 268, 270 with the plurality of passages 272 disposed between the two guards 278, 280.

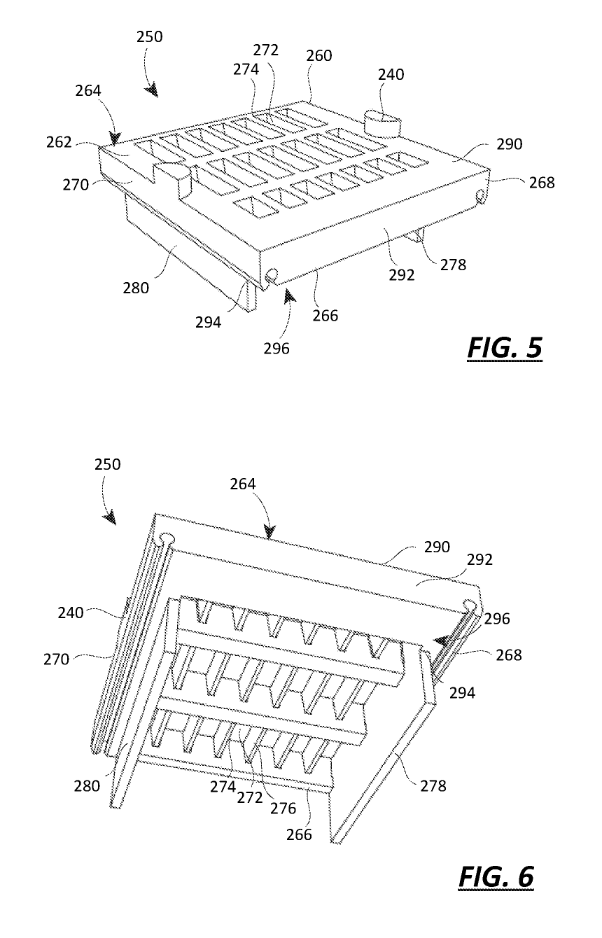

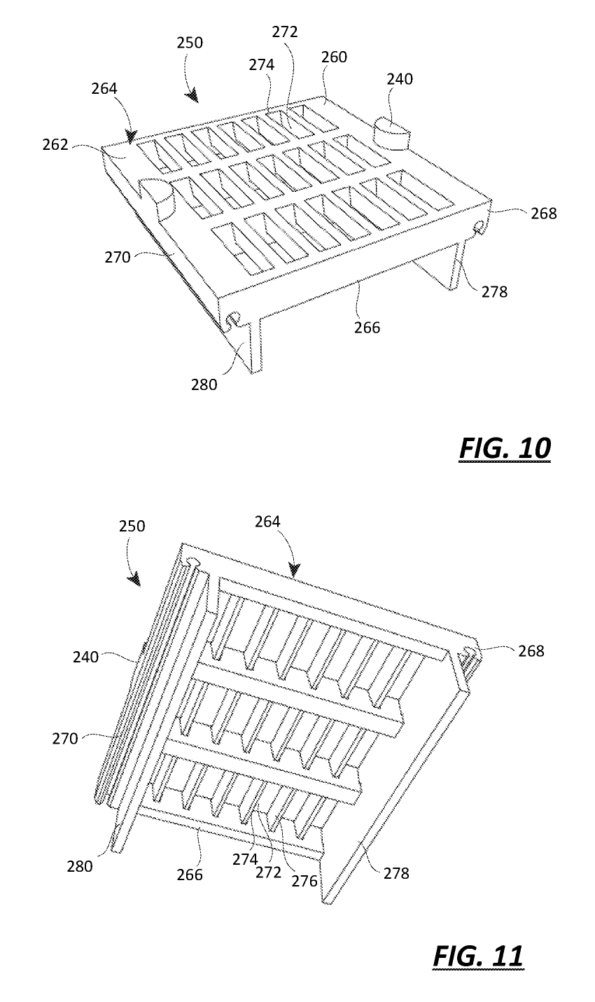

In fact, as illustrated in FIG. 4, the plurality of panel modules may include a first and a second end panel module 250 and at least one intermediate panel module 252. The end panel modules 250 are illustrated in detail in FIGS. 5-9, while the intermediate panel modules 252 are illustrated in detail in FIGS. 10 and 11. It will be recognized that, while the panel illustrated in FIG. 4 has an end panel module 250 at either end, a panel could have an end that terminates in an intermediate panel module as described below (i.e., a panel module without an overhang). It will be further recognized that the terms “end” and “intermediate” are with reference to the illustrated embodiment, and that the terms “first” and “second” may be substituted instead.

As illustrated in FIGS. 4 and 5-9, the first end panel module 250 has an end 290 in addition to the top 262, bottom 266 and opposite sides 268, 270, the end 290 of the panel base 260 of the first end panel module 250 terminating at a transverse end edge 292. The first and second guards 278, 280 of the first end panel module 250 depend from the bottom 266 of the panel base 260 from a point 294 spaced from the end edge 292 to define an overhang 296 at the first end 290 between the end edge 292 and the point 294. In a similar fashion, the second end panel module 250 also has an end 290 in addition to the top 262, bottom 266 and opposite sides 268, 270, the end 290 of the panel base 260 of the second end panel module 250 terminating at an transverse end edge 292, with the edge 292 of the second end panel module 250 disposed opposite the end edge 292 of the first end panel module 250. The first and second guards 278, 280 of the second end panel module 250 depending from the bottom 266 of the panel base 260 from a point 294 spaced from the end edge 292 to define an overhang 296 at the second end 290 between the end edge 292 and the point 294. As such, either the first or the second end panel module 250 may be as illustrated in FIGS. 5-9.

On the other hand, the at least one intermediate panel module 252 does not include an overhang 296. However, the module 252 still includes a top 262, a bottom 266, opposite sides 268, 270, and first and second guards 278, 280, as illustrated in FIGS. 10 and 11. It will be recognized that the guards 278, 280 may be slightly spaced from either edge to define an intermittent guard along the length of the assembly panel including one or more end panels 250 and/or intermittent panels 252, similar to that illustrated in FIG. 12. Such an embodiment may still differ from that illustrated in that the overhangs 296 do not include passages 272 in the overhangs 296.

Although the preceding text sets forth a detailed description of different embodiments of the invention, it should be understood that the legal scope of the invention is defined by the words of the claims set forth at the end of this patent. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112.

What is claimed is:

1. A vibratory apparatus comprising:
a deck comprising at least one deck panel, the at least one deck panel comprising:
a panel base having a top defining an upper, load-bearing surface, a bottom disposed opposite the top, and first and second opposite sides,
a plurality of passages, each passage connected between an upper opening disposed in the upper, load-bearing surface and a lower opening on the bottom, and
first and second guards depending from the bottom of the panel base, each of the guards disposed along one of the first and second opposite sides with the plurality of passages disposed between the two guards; and
an exciter coupled to the at least one deck.

2. The vibratory apparatus of claim 1, wherein the first side of the panel base terminates a first longitudinal side edge and the second side of the panel base terminates at a second longitudinal side edge, the first guard being spaced from the first side edge and the second guard being spaced from the second side edge.

3. The vibratory apparatus of claim 2, further comprising first and second channels, each of the first and second channels defining a female connector, the first channel disposed between the first side edge and the first guard and the second channel disposed between the second guard and the second side edge.

4. The vibratory apparatus according to claim 1, further comprising a deck frame, the deck frame comprising a plurality of longitudinally-directed male connectors, wherein the panel comprises a first female connector disposed between the first guard and a first longitudinal side edge and a second female connector disposed between the second guard and a second longitudinal side edge disposed opposite the first side edge, a first of the male connectors received in the first female connector and a second of the male connectors received in the second female connector.

5. The vibratory apparatus of claim 4, wherein the panel base comprises a rectangular parallelepiped having first and second opposite ends in addition to the top, bottom and opposite side edges, the first and second guards depending from the bottom of the panel base between the first end and the second end of the panel base.

6. The vibratory apparatus of claim 5, wherein the first and second guards depend from the bottom of the panel base continuously between the first end and the second end.

7. The vibratory apparatus of claim 5, wherein the first and second guards depend from the bottom of the panel base intermittently between the first end and the second end.

8. The vibratory apparatus of claim 4, wherein the first end of the panel base terminates at a first transverse end edge and the second end of the panel base terminates at a second transverse end edge, and the first and second guards depending from the bottom of the panel base between a first point spaced from the first end edge to a second point spaced from the second end edge to define a first overhang at the first end and a second overhang at the second end.

9. The vibratory apparatus of claim 8, wherein the first and second guards depend from the bottom of the panel base intermittently between the first point and the second point.

10. The vibratory apparatus of claim 8, wherein the plurality of passages are disposed in a plurality of transverse rows, each row disposed between the first guard and the second guard, and none of the plurality of passages disposed in the first overhang or the second overhang.

11. The deck panel of claim 5, wherein the guards each comprise a rectangular parallelepiped disposed at right angles to the panel base.

12. The vibratory apparatus according to claim 1, wherein the deck comprises a plurality of transverse rows of deck panels, each row comprising a plurality of deck panels.

13. A deck panel comprising:
a panel base having a top defining an upper, load-bearing surface, a bottom disposed opposite the top, and first and second opposite sides;
a plurality of passages, each passage connected between an upper opening disposed in the upper, load-bearing surface and a lower opening on the bottom; and
first and second guards depending from the bottom of the panel base, each of the guards disposed along one of the first and second opposite sides with the plurality of passages disposed between the two guards.

14. A vibratory apparatus comprising:
a deck comprising at least one deck panel, the at least one deck panel comprising a plurality of panel modules, each panel module comprising:
a panel base having a top defining an upper, load-bearing surface, a bottom disposed opposite the top, and first and second opposite sides;
a plurality of passages, each passage connected between an upper opening disposed in the upper, load-bearing surface and a lower opening on the bottom; and
first and second guards depending from the bottom of the panel base, each of the guards disposed along one of the first and second opposite sides with the plurality of passages disposed between the two guards; and
an exciter coupled to the at least one deck.

15. The deck panel according to claim 14, wherein the plurality of panel modules comprises a first end panel module, a second end panel module and at least one intermediate panel module,
wherein the first end panel module has an end in addition to the top, bottom and opposite sides, the end of the panel base of the first end panel module terminating at a transverse end edge, and the first and second guards of the first end panel module depending from the bottom of the panel base from a point spaced from the end edge to define a first overhang at the first end between the end edge and the point,
wherein the second end panel module has an end in addition to the top, bottom and opposite sides, the end of the panel base of the second end panel module terminating at an transverse end edge opposite the end edge of the first end panel module, and the first and second guards of the second end panel module depending from the bottom of the panel base from a point spaced from the end edge to define a second overhang at the second end between the end edge and the point, and
the at least one intermediate panel module is disposed between the first end panel module and the second end panel module.

16. The deck panel according to claim 14, wherein the first end panel module, the second end panel module and the at least one intermediate panel module are formed as a single piece.

17. The vibratory apparatus according to claim 14, wherein the deck comprises a plurality of rows of deck panels, each row comprising a plurality of deck panels.
